(19) United States
(12) Patent Application Publication
(10) Pub. No.: US 2008/0105826 A1
(43) Pub. Date: May 8, 2008

(54) Structures Useful in Creating Composite Left-Hand-Rule Media

(76) Inventors: Peter K. Mercure, Midland, MI (US); Robert P. Haley, Midland, MI (US); Chris P. Christenson, Lake Jackson, TX (US)

Correspondence Address: The Dow Chemical Company, Intellectual Property Section, P.O. Box 1967, Midland, MI, 48641-1967, US

(21) Appl. No.: 11/795,161

(22) PCT Filed: Jan. 18, 2006
(86) PCT No.: PCT/US06/01624

§ 371 Date: Jul. 12, 2007

Related U.S. Application Data
(60) Provisional application No. 60/644,599, filed on Jan. 18, 2005.

(51) Int. Cl. H01Q 1/36; G01N 22/00

(52) U.S. Cl. 250/394; 343/895

(57) ABSTRACT

This invention relates to structures which display negative magnetic permeability in response to a relatively broad range of wavelengths. This invention further relates to manufacture of negative magnetic permeability or negative electric permittivity structures by rapid prototyping methods. Finally, this invention relates to structures which display negative permittivity and negative permeability and are open cell structures.

### BACKGROUND

The instant invention relates to structures with negative effective magnetic permeability properties. More specifically, the instant invention relates to multiple stranded helical shaped structures with negative effective magnetic permeability properties.

The optical properties of a material depend on the magnetic permeability and electric permittivity of that material. The magnetic permeability μ is defined as the constant of proportionality between the magnetic induction and the applied magnetic field. B=(μ)(H). The electric permittivity \acute{ε} is defined as the constant of proportionality between the electric displacement and the applied electric field: D=(ε)(E).

The variables, B, H, D, and E, are all vector quantities. In the case of linear, homogeneous, isotropic materials, μ and ε are scalar constants. The same relationships hold in the case of non-linear materials where the relationships become field dependant, i.e. μ becomes μ(H) and ε becomes \acute{ε}(E). In non-homogeneous or anisotropic materials, μ and ε become tensor quantities where the degree of response varies with the direction of the applied field (varying diagonal components of the tensor), and an applied field in one direction can induce a response in orthogonal directions (off-diagonal components of the tensor). In non-homogeneous materials, μ and \acute{ε} become dependant on spatial position; for example, μ becomes μ(x,y,z) and ε becomes ε(x,y,z). The most common non-homogeneity in an optical system is the interface surfaces between different materials, for example the interfaces between glass and air in a lens.

All materials are inhomogeneous at a sufficiently small length scale, so we observe “effective” values of μ and ε. Commonly, the electromagnetic properties are the result of atomic and molecular phenomena so at the length scale of most optical elements, the materials can be considered homogeneous. Conductors and non-conductors can be fabricated into electrically active structures such as antennas and circuit boards. If the features of these structures are sufficiently small with respect to the wavelength of an impinging electromagnetic wave, there can be a response that is an effective material property. A fabricated material with an effective bulk property, such as μ or ε, has been called a meta-material. There is much current interest in designing meta-materials with specific properties.

Most materials have values of μ and ε that are greater than zero. However, in his pioneering paper, Veselago considered what would happen if a material had μ and \acute{ε} values that were less than zero, (Sov. Phys. USPEKHI 10(4), pp 509-514, 1968). Veselago concluded that the phase propagation in such a material would form a left-handed coordinate system with the electric and magnetic vectors compared to the right-handed coordinate system formed in more conventional materials. Veselago concluded his paper with a search for such “left-hand rule” materials. He could find negative μ or negative ε materials, but Veselago found no materials that had both properties.

Pendry discussed the fact that optical components that follow the left-handed phase-propagation rule could be perfect lenses allowing sub-wavelength imaging, Physical Review Letters 85(18) pp 3966-3969 (1999). The elimination of the diffraction limit in imaging systems has many advantages and many promising commercial applications, and thus motivates the design of meta-materials with the desired properties. Pendry et al showed a “split-ring resonator” structure that has a negative effective magnetic-permeability when illuminated by electromagnetic radiation in a certain range of frequencies, IEEE Transactions on Microwave Theory and Techniques 47(11), pp 2075-2084 (1999). These frequencies depend on the dimensions of the rings. Pendry et al. also described a number of other negative effective magnetic-permeability structures, U.S. Pat. No. 6,608,811, herein fully incorporated by reference.

Pendry et al. also demonstrated structures that could generate a negative effective electric-permittivity in certain frequency ranges, Physical Review Letters 76(25) pp 4773-4776 (1996). Shelby et al. have combined both of these elements and have demonstrated a metallic structure having a negative index of refraction, Science 292, 77 (2001) and USPAP 2001/0038325 A1, herein fitly incorporated by reference. This type of structure should be capable of sub-wavelength imaging in the microwave region of the electromagnetic spectrum. Materials of this nature have been described as “left-handed meta-materials.”

In addition to the structures discussed above, a number of other structures having negative effective magnetic-permeability have been proposed. For example, Gay-Balmaz and Martin theorized that the metallic conductors do not have to be annuli, Applied Physics Letters 81(5), 939 (2002) and attempted to form isotropic negative effective magnetic permeability materials, but apparently achieved only two directions of equivalent response or two-dimensional isotropy. Engheta showed that an “omega” structure can demonstrate negative effective magnetic permeability at certain frequencies, IEEE International Symposium on Antennas and Propagation (2002).

It would be an advance in the art of structures having negative effective magnetic-permeability if additional structures were discovered that had increased bandwidth—i.e. broader range of wavelengths to which they had negative effective magnetic permeability responses, especially if such new structures could be fabricated using self-assembled chemical materials to produce meta-materials of negative effective magnetic permeability at wavelengths of electromagnetic radiation in the IR, visible and UV ranges.

Further it would be desirable to have structures that do not require the composite structure previously required to achieve simultaneously negative magnetic permeability μ and negative electrical permittivity ε.

### SUMMARY OF THE INVENTION

According to a first embodiment, the instant invention provides new structures with negative effective magnetic permeability properties and good bandwidth. It is believed that the new structures of the instant invention maybe fabricated using self-assembled chemical materials to produce meta-materials of negative effective magnetic permeability at wavelengths of electromagnetic radiation in the IR, visible and UV ranges.

Thus according to one embodiment, the instant invention is a structure comprising an array of capacitive elements, each capacitive element including a low resistance conducting path provided by a conductor having a major and a minor dimension in cross-section perpendicular to the path, and being such that a magnetic component of received electromagnetic radiation lying within a predetermined frequency band induces an electrical current to flow around the path and through the associated element and the elements having a size and a spacing apart from one another selected such as to provide a negative effective magnetic permeability over a selected frequency range in response to the received electromagnetic radiation, the conductor being in the shape of a multiple helix and having a pitch angle of greater than about 30°. Another embodiment of the instant invention is a medium operable to have at least one frequency band in which both effective μ and effective ε are negative simultaneously, the medium comprising: (a) a negative μ medium comprising the s of the first embodiment of the invention; and (b) a negative ε medium spatially combined with said negative μ medium to form the composite medium having a frequency band in which both effective μ and effective ε are negative.

In another preferred embodiment, the instant invention exploits the availability of self-assembled materials, such as multi-helical natural and synthetic polymers (the term polymer herein includes oligomer, macromolecule or poly-annulated-conjugated molecule), to produce a structure that provides a magnetic permeability of about minus one in the IR, visible or UV frequency range. The structure of the instant invention is useful, for example, in an improved method for producing an integrated circuit including the step of photolithography of a mask work by projecting an image of a mask onto a substrate using an imaging optical system, wherein the improvement comprises an imaging optical system that incorporates the structure of the instant invention.

Another embodiment of the instant invention is a method for providing a negative effective magnetic permeability over a selected frequency range in response to received electromagnetic radiation, comprising the step of positioning the structure of the instant invention in electromagnetic radiation of the selected frequency range.

Finally, another embodiment of the instant invention is a medium operable to have at least one frequency band in which both effective μ and effective ε are negative simultaneously, the medium comprising: (a) a negative μ medium; and (b) a negative ε medium spatially combined with said negative μ medium to form the composite medium having a frequency band in which both effective μ and effective ε are negative, the negative ε medium comprising an open cell conductive structure.

### DETAILED DESCRIPTION OF THE INVENTION

According to the first embodiment, the central theme of the instant invention is the use of a conductor in the shape of a multiple helix with a relatively high pitch angle to achieve negative effective magnetic permeability properties over a relatively broad selected frequency range in response to electromagnetic radiation. The term “helix” herein means that the conductors are shaped as a thee dimensional space curves around a central axis where there are at least two curves interspersed with each other but not contacting each other. The three dimensional space curve can take any shape such as, without limitation thereto, a circular shape, an oval shape, a square shape, or any combination thereof. The helix can be wound from from two or more conductors. For example, the helix can be a double helix. The helix can be a “discontinuous helix” as discussed below. The conductor provides a low resistance conducting path for a capacitive element The term “low resistance” means a resistivity of less than twelve micro-Ohm-meter at the selected frequency range. The conductor has a major and a minor dimension in cross-section perpendicular to the path and the ratio of the major dimension to the minor dimension of the conductor in cross-section perpendicular to the path is preferably less than ten.

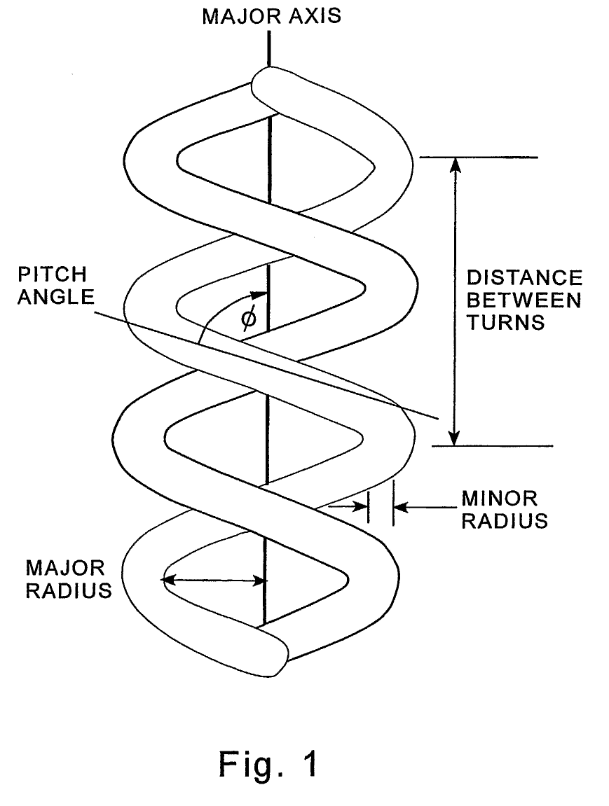

The pitch angle has been found by the inventors to be critical to giving broader range of wavelengths at which the structure provides a negative magnetic permeability response. Pitch angle can be calculated as follows (see also FIG. 1):

If the distance between turns has the value of b, and the major radius of the coil has the value of a, then the cosine of the pitch angle=b divided by the square root of (â2+b̂2).

$$Cos [ φ ] = \frac{b}{\sqrt{{a}^{2} + {b}^{2}}}$$

An effective pitch angle could be calculated for the “blocky helix” or any other irregular helix by using an average distance to the axis and an average distance between turns. As a coil becomes stretched out, b will become very large, b/sqrt(â2+b̂2) will go to one and the pitch angle will go to zero. As b becomes small, the pitch angle goes to 90 degrees. So for action as a resonator higher pitch angles approaching 90° are desired.

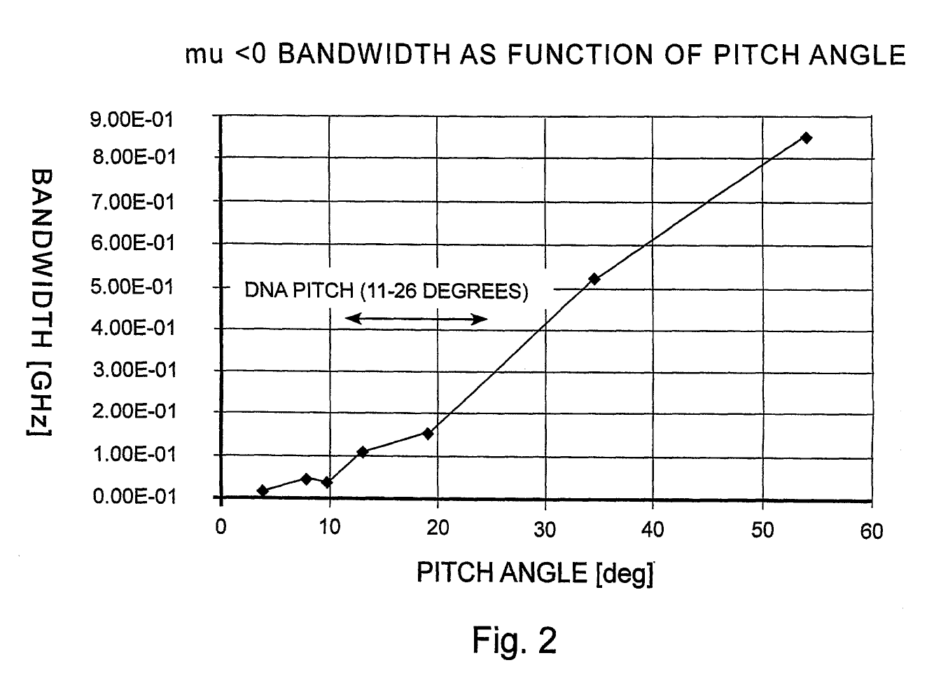

Applicants determined that DNA which has pitch angles in the range of about 10 to about 25° have narrower bandwidths than double helices having pitch angles greater than 30°. See FIG. 2.

One embodiment of the instant invention comprises a double helix of 0.5 millimeter diameter copper wires, the helix having an outside diameter of 4 millimeters and a pitch or distance between turns of 2 millimeter, to produce a structure that provides a magnetic permeability of about minus one at a radio frequency in the 1-10 GHz range. However, smaller helix structures are required to obtain a magnetic permeability of about minus one in the IR, visible or UV range where the wavelength of the electromagnetic radiation is shorter. It is believed that such smaller helix structures can be obtained by using “self-assembled materials”, such as helical and multi-helical natural and synthetic polymers, as well as carbon micro-coils and carbon nano-coils.

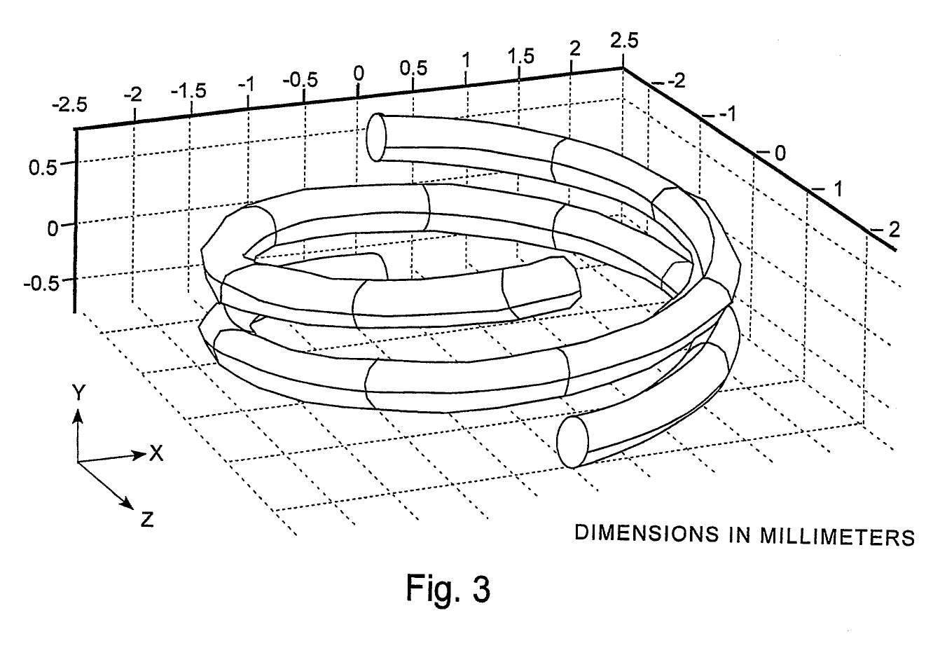

To analyze multiple helix structures, the multiple helix may be illuminated by plane-polarized light in an electromagnetic transport model. The resulting fields will be analyzed to determine the effective response of the material in terms of the optical material parameter of magnetic permeability. See FIG. 3 for an example of a double helix to be analyzed.

The excitation of this system will be a plane wave incident on the z=0 plane; the wave exits at the port at the point of maximum z. One then solves for the three-dimension wave-propagation governed by Maxwell's equations which in the differential form are:

∇×H=J+∂D/∂t

∇×E=−∂B/∂t

∇V·D=ρ

∇·B=0

Using the constitutive equations for linear isotropic homogeneous materials of construction (in this system they are typically assumed to be vacuum and metal): B=μH, D=εE, and J=σE, with no fixed charge density (ρ=0) these equations reduce to:

∇×H=σE+∈∂E/∂t

∇×E=−μ∂H∂t

∇·D=0

∇·B=0

Because the excitation is periodic, one can determine the “time-harmonic” solution of the system; this is the periodic solution after many wave fronts have passed and the transient response has decayed away. This allows the time varying fields to be expressed in separable form:

E[x,y,z,t]−E[x,y,z]e^{i,ω,t}

H[x,y,z,t]=H[x,y,z]e^{i,ω,t}

where ω is the frequency of excitation.

### Lumping all losses (ohmic and polarization) into an imaginary part of the permittivity with an effective resistivity (σ):

∈=∈ᵣₑₐₗ−i∈_{imaginary}=∈ᵣₑₐₗ−iσ/ω

The first two Maxwell equations can be combined into:

∇=(μ⁻¹∇×E)−·ω²E=0

∇×(μ⁻¹∇×H)−μω²H=0

Either of these equations can be solved to find the fields for the system. Periodic conditions are forced in the model by a combination of the boundary conditions chosen and forcing the mesh points on opposing faces to be equivalent. Because of the symmetry of the problem and the fact that we will use a plane-polarized wave for excitation, the boundary conditions are simplified.

The faces perpendicular to the x-axis are perpendicular to the direction of the electric polarization in this system and we enforce the condition of a “perfect electric conductor” or:

n×E=0

### This is consistent with a periodic system in the x-axis direction.

The faces perpendicular to the y-axis are perpendicular to the direction of the magnetic polarization in this system and we enforce the condition of a “perfect magnetic conductor” or:

n×H'20=n×i/ω∇×E

### This is consistent with a periodic system in the y-axis direction.

The faces used for input to and output from the overall geometry are given a “low-reflecting” boundary condition to approximate a semi-infinite space outside of each boundary:

Square root of (μ(∈−iσ/ω))×n×H+E−(n·E)n=2E₀−2(n·E₀)n+2×(squareroot of (μ/(∈−iσ/ω)))n×H

The incident plane wave is modeled by the boundary conditions at the z=0 plane. The E field component in the x-axis direction is given a value of 1, while all other E-field components are set to zero. All H-field components on the boundary are set to zero. This gives an incident plane wave with the electrical component polarized in the direction of the x-axis.

At the exit port, all E- and H-field components are set to zero. This gives no excitation at this port and has the effect of having a boundary that effectively represents a transition to a semi-infinite space. The important aspect is that there is minimal reflection from this boundary back into the space in which one is solving for the electromagnetic fields.

Periodicity in the z-axis direction is approximated by three repeated structures spaced in the z direction.

The surfaces of the helices are represented by “perfect electrically conducting” boundaries. This gives the behavior of a conducting material without requiring that the interior of the helices be meshed, which would increase the memory and time required for the solution with no gain in accuracy or precision. One may run these calculations for example with a finite element system such as FEMLAB (2.3).

The finite element mesh used by FEMLAB is generated using these typical values for program specific parameters: “mesh edge size scaling factor”=“hmaxfact”=1.9, “mesh growth rate”=“hgrad”=1.6, “mesh curvature factor”=“hcurve”=0.6, and “mesh curvature cutoff”=“hcutoff”=0.03. This results in a typical value of 5489 nodes and 30531 degrees of freedom or defining equations in the solver. An iterative solver such as GMRES or Generalized Minimal RESidual may be used. This solver is used with an incomplete LU preconditioner. The FEMLAB solver generates a data structure, which can be used to extract the values of various fields in the model and make calculations on these fields.

The input port boundary condition acts as an excitation in the E field; only the x-component is applied so this is plane polarized light. Because of the symmetry of the helical shape, the only substantial magnetic field generated by the shape is in the y-axis direction. Note also, that the magnitude of the magnetic field is much greater on the interior of the helix and if there are several helices in a row in certain rings will point in the opposite direction from the field in the exterior of the helices.

Further analysis, shows the y-component of the magnetic field intensity (Hy) on a plane that cuts the helical coils midway along their length along the y-direction. This analysis shows a maximum in the field strength somewhere between 5 and 6 GHz, more preferably between 5.0 and 5.2 gHz.

The measurement of the effective magnetic permeability is based on the analysis of the fields determined from the periodic solution to Maxwell's equations. The method used here is based on evaluating the current flowing in the structure and calculating an effective induced magnetic dipole. The magnetic permeability is calculated from knowing the applied field and calculating the effective induced field from the induced magnetic dipole. Applying this analysis to the field data for various helix inclusions gives the following plots for the real and imaginary parts of the magnetic permeability as a function of frequency.

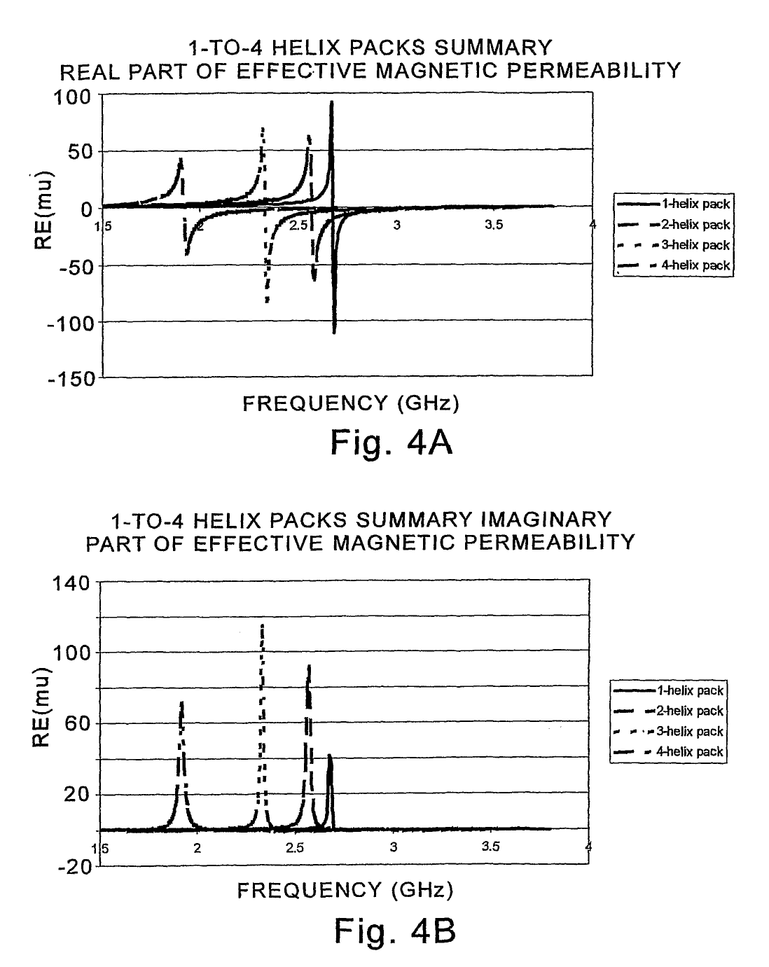

The combined plots of single, double, triple and quadruple helices in FIGS. 4a and 4b show relative differences between the various structures.

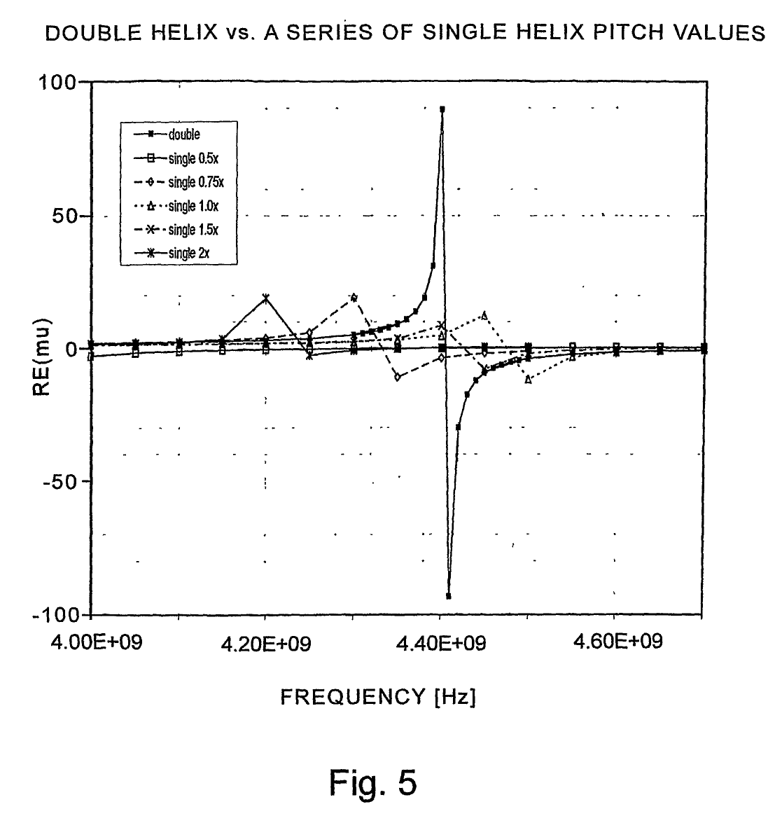

Multiple helices are found to have significantly larger magnitude response compared to single helices as is seen further in FIG. 5. A series of calculations was performed to compare the response of a single-helix metal-coil resonator to the response of a double-helix metal-coil resonator. A typical geometry was selected for the double helix that yielded a resonant frequency in the gigahertz range. The same major diameter (overall outer diameter, 6 mm) and minor diameter (conductor diameter, 0.5 mm) was used for a series of single helix structures. The pitch of the single helix was varied in multiples of the pitch used for the comparison double helix (4 mm); values of 0.5, 0.75, 1, 1.5, and 2 times the double helix pitch were used (2 mm, 3 mm, 4 mm, 6 mm, and 8 mm). FIG. 5 shows the magnetic response for the real part of the effective magnetic permeability in the direction of the applied field.

One can see that the magnetic response of the double helix is considerably larger in magnitude than that of any of the single helices. Since this magnetic resonator is designed to be used as a part of an effective meta-material, a stronger response will allow the spacing of the resonators to be farther apart in the effective material. Conversely, the region of negative magnetic permeability will span a much greater range of frequencies for the double helix compared to the single helix; this may become important to increase the effective frequency range of a negative mu meta-material.

According to one preferred embodiment the multiple helices of this invention are self-assembled structures. While others have suggested such self-assembled structures as DNA, as noted above DNA is not as desirable as the presently claimed structures due to its relatively low pitch angles (See FIG. 1). In addition, DNA has a low inherent conductivity which would also render it not highly useful. In contrast, certain block copolymers have been found to microphase segregate into multiple helices. See e.g. U. Krappe, R. Stadler, and I. Voigt-Martin, “Chiral Assembly in Amorphous ABC Triblock Copolymers. Formation of a Helical Morphology in Polystyrene-block-polybutadiene-block-poly(methyl methacrylate) Block Copolymers,” Macromolecules 1995(28), 4558-4561; and

U. Breiner, U. Krappe, V. Abetz, R. Stadler, Macromol. Chem. Phys. 198, 1051 (1997). In addition, such microphase segregated shapes can be used as templates for deposition of metals which can form a path for electrical current. See e.g. M. Brust, M. Walker, D. Bethell, D. J. Schriffin, R. Whyman, J. Chem. Soc., Chem. Commun., 801 (1994); D. V. Leff, P. C. Ohara, J. R. Heath, W. M. Gelbart, J. Phys. Chem., 99, pp 7036 (1995); and C. K. Yee, R. Jordan, A. Ulman, H. White, A. King, M. Rafailovich, J. Sokolov, Langmuir, 15, pp 3486 (1999).

While such self-assembled, and partially self-assembled structures are useful, fabricated materials such as by rapid prototyping methodology can also be useful.

It should be understood that when the conductor(s) of the instant invention is(are) a string-bead arrangement of metal spheroids (such as metal microspheres associated with DNA to form a double helix nanowire system), the ratio of the above discussed major dimension to the minor dimension of the conductor(s) is about one. And, of course, when a conventional circular cross-section wire is used in the indent invention, then the ratio of the above discussed major dimension to the minor dimension of the conductor(s) is also about one.

As discussed above in some detail but without limitation thereto, various helical structures are useful in producing meta-materials generating a magnetic response from non-magnetic materials. The magnetic permeability response can be less than zero over a range of frequencies, for example, from the radio frequency range to the extreme UV range. Self-assembled helical forms have size dimensions that are believed to be especially useful in producing structures of the instant invention having a negative effective magnetic permeability response in the IR, visible or UV range.

The structures of the instant invention are useful in a wide range of applications such as (and without limitation thereto) microwave circuit devices, microwave imaging systems for medical or security applications, electromagnetic shielding systems, improved antennas and transmission lines, impedance matching components, replacing IC inductors with negative capacitors, nano-printing and near perfect lenses and lens systems such as microscopes and telescopes that are not diffraction limited.

To produce a Negative Index or Left-Hand-Rule material, a negative electric permittivity (epsilon) is needed in addition to a negative magnetic permeability (mu. It is well known that plasma, a metal, or a closed single-conductor waveguide will have a frequency dependent behavior characterized by a value for a “plasma frequency” (See Wangsness, 1986, ELECTROMAGNETIC FIELDS, p 433) below which the effective value of epsilon goes negative. Pendry (See Pendry et al., June 1996, Physical Review Letters 76(25), p 4773) proposed a conducting cubic wire mesh structure and predicting that it has an effective plasma frequency much lower than the metal used to construct it.

It has been shown that it is theoretically possible for a metal wire mesh to behave as a solid metal specimen to the extent that the mesh too, has a plasma frequency, below which electromagnetic waves will reflect and above which waves will pass (See, Pendry et al., 1998, J. Phys: Condensed Matter 10, p 4785-4890). Specifically, the frequency-dependent electric permittivity of metals takes the form (no losses):

$$ɛ ( ω ) = 1 - \frac{{ω}_{p}^{2}}{{ω}^{2}} , \qquad ( 1 )$$

where ωₚ is the “plasma frequency” of the metal.
The plasma frequency for a mesh formed of wires of radius r, and spaced a apart is approximately:

$${ω}_{p}^{2} = \frac{2 π {c}_{0}^{2}}{{a}^{2} ln ( a / r )} , \qquad ( 2 )$$

where c₀ is the speed of light in vacuum.
As an example of the use of equations (1) and (2), to achieve a double-negative material in the instant invention for imaging, for example, using a cubic mesh, operating around 2.4 GHz, we need ε(ω)=−1. This requires a plasma frequency 3.4 GHz according to the above theory. Using AWG46 wire (0.02 mm radius), the resulting lattice constant would be 14.4 mm to achieve 3.4 GHz plasma frequency (or a wavelength of 8,8 centimeters). The ratio between lattice and wire size is 720.

By contrast, the calculated wavelengths corresponding to the measured plasma frequencies for solid (everywhere continuous) metals are in the UV part of the spectrum. Some examples are:

| Metal | Wavelength (nm) |
|---|---|
| Li | 174.3 |
| Na | 217.3 |
| K | 333.5 |
| Mg | 117.0 |
| Al | 81.1 |

In equation (2) above, the factor ln(a/r) comes about by considering the magnetic field locally to any wire segment in the mesh. This means that the resulting magnetic field can essentially be ignored out near the center of a cube of such material. We propose that the same arguments used by Pendry hold for non-cubic meshes as well, and that the same formulas will essentially apply to them given that the equivalent lattice constant, a, is calculated as:

a=V_{cell}^{1/3}, (3)

where V_{cell} is the volume of the unit cell of the non-cubic mesh.

Pendry indicates: “wires are to be assembled into a periodic lattice and, although the exact structure probably does not matter, we choose a simple cubic lattice.” Sievenpiper (See, Sievenpiper et al., April 1996, Physical Review Letters 76(14), p 2480) as investigated another structure based on a diamond lattice and shown behavior consistent with a plasma frequency description. This led the present inventors to consider other structures that may be self-assembled in nature and manifest a negative epsilon.

In the final embodiment, the present inventors propose that electrically-conductive (including metal) open-cell foams, for example as shown below, will produce a plasma frequency and dielectric function as shown in equations (1) and (2) and thus be useful as a negative μ medium in the instant invention.

Furthermore, the mesh does not have to be truly periodic. The distribution of unit-cell sizes in the foam may help to produce a band of frequencies, centered about the average unit-cell size, where the electric permittivity is near −1. This would be advantageous where wider bandwidth is a requirement. In conjunction with resonators producing magnetic dipole moments, “wideband” negative index materials should be possible. Lenses can be formed to be used in polychromatic sub-wavelength imaging.

Based on Pendry's theory, the following items must hold true in wire meshes used in this manner:

a. The wires in comprising the mesh must maintain electrical continuity at vertices (no breaks)
b. Only modes whose electric fields are parallel to the wires will reduce to “free-photons”, that is, propagating transverse modes in free space. The longitudinal modes are responsible for the plasmon response.
c. Wires must be very thin to have only longitudinal plasmons, and hence the simple plasma frequency-dependent permittivity as in solid metals. A factor of 100-1000 or more between the lattice spacing and wire diameter is required.

Metal foams useful in the instant invention can be made from plastics or other familiar polymers with reasonable mechanical properties, as the structure should preferably be robust in handling. Once blown a polymer foam can be coated with a thin metal layer a few microns in thickness. Hence, each strut in the original foam will become a hollow conductor. Equation (2) above will have the wire radius replaced by the radius of the hollow conductor. Suitable metal structures can otherwise be formed for such use in the instant invention, such as by the electroforming procedure of U.S. Pat. No. 4,053,371.

The exact same arguments in Pendry's theory apply to a hollow conductor as well as to a solid metal wire. This is true in theory as long as the radius of the hollow conductor is small compared to the lattice constant, just as the radius of the wire had to be small compared to the lattice constant of the mesh.

The constraint in the relative sizes of the conductors and the mesh spacing is required so the magnetic field in the vicinity of the conductors can be approximated in the same fashion.

Therefore, a formula for the open-cell foam is:

$${ω}_{p}^{2} = \frac{2 π {c}_{0}^{2}}{{a}^{2} ln ( a / r )} , \qquad ( 3 )$$

where 2 r is the thickness of the hollow conductor.

As an example, for a strut thickness of 1 mm and an effective lattice constant of 10 mm, the corresponding plasma frequency is 6.91 GHz.

### EXAMPLES OF THE VARIOUS EMBODIMENTS OF THE INSTANT INVENTION

### Example 1

As far as we know, cubic grids do not appear in self-assembling systems in nature, but we knew that foams are another open-cell grid that does appear frequently. Open cell foams of the dimensions of our cubic grid test are not commonly available, so we opted to test using an idealized foam structure. Lord Kelvin studied the problem of minimizing the surface area of bubble cells in foam and proposed an idealized structure that satisfied a number of conditions found in foam and stood for a century as having the lowest surface to volume ratio for a space-filling polyhedron. This structure is a slight variation on a tetradecadedron which is a structure along the continuum of shapes between the polyhedral duals of a cube and an octahedron. We took this structure as idealized foam and constructed a grid of wires in this shape for testing within an S-band waveguide.

Three types of wire grids may be configured inside a section of S-band waveguide. One type has a cubic grid with the vertical and horizontal wires connected at vertices. A second type is a cubic grid with the vertical and horizontal wires not touching. The third type is a tetradecahedron sized such that the cell size was equivalent to that of the cubic grids.

Modeling for transmission and fitting the experimental data for the cubic grids gives values of 4.8 GHz for the plasma frequency consistent with the formula in Pendry, which gave 3.8 GHz. Pendry's analysis was supported by the identical behavior of the two different grids. The tetradecadahedron gives very similar results (4.4 GHz) to the cubic grids, with one unusual result. The tetradecahedron had two spikes in transmission that might indicate an internal magnetic resonance causing the structure to approach the behavior of a photonic crystal or a double negative material.

The technology of rapid prototyping allows a very precise building of structures that are described in a mathematical format as a series of triangulated interface surfaces. In practical terms, rapid prototyping can build just about any physically realizable shape possible. For example, one may use a photo-polymerization printer to construct polymer grids which we then coated with a metallic layer.

### Example 2

One may fabricate multiple-helix structures, designed to operate in the s-band to x-band using both manual assembly and rapid prototyping techniques. The mutual capacitance depends on the total length of wire comprising the helices and the gap between them. The inductance depends on the number of turns and the radius of the helix pack. So pitch, relative axial position and the number of turns are the tuning parameters. The desired overall size constrains the length and diameter.

The typical cross-sectional shape of helices is circular. One may fabricate square cross-sections for the increase inductance this shape offers. We can replace a helix of constant pitch with a series of zero pitch split rings electrically connected by means of short wire segments parallel to the primary axis of the helix, such that we realize an average pitch for this “discontinuous” helix. Constructing the helix this way improves the precision of the rapid prototyping system.

By intercalculating the rings according to the instant invention, there is a structure that can have identical resonators aligned in each of the principle coordinate directions so that the response in all three directions is equal.

Closer packing can be achieved by utilizing a body centered cubic packing of the intercalculated sets of rings. In addition, the inclusions could be fabricated as beads allowing a random packing of the magnetic meta-material. This idea of intercalculating the resonators can be applied to ring resonators and helical resonators of circular or square cross-section.

One may form the magnetic inclusions and electric grid using a rapid prototyping technique. The magnetic inclusions can not be connected electrically so there is a problem suspending the magnetic inclusions within the electric grid. This can be solved by using a technique employing both a “build” material that is electrically conducting and a “support” material that is an insulating dielectric. Thus the conductors forming the magnetic inclusions are held apart by a dielectric support material.

One may form the magnetic inclusions and electric grid using much the same rapid prototyping technique as used for the magnetic inclusions. The magnetic inclusions are arranged in the cubic lattice that is formed by the three-dimensional grid that gives rise to the negative permittivity. The rapid prototyping machine used produces structures up to about 20 cm on a side. Blocks of thousands of such can be constructed, and then stacked to form a lens of the desired size and geometry.

### Example 3

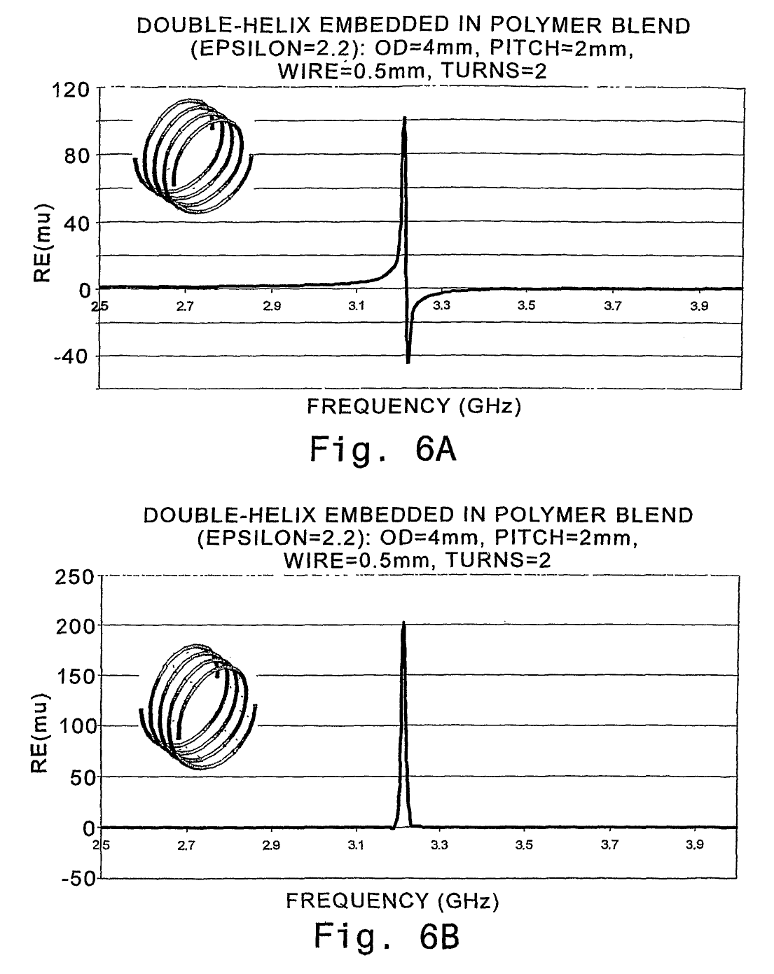

A double helix of 0.5 millimeter diameter copper wire is wound on a 4 mm polyethylene rod. The pitch, or distance between turns, is 2.0 millimeters. The helix has 2 turns. Three sets of these structures are arranged in a rectangular cell in order to illuminate them with plane wave electromagnetic radiation with the results as shown in FIGS. 6a and 6b.

### Example 4

A double helix of 0.3 millimeter diameter copper wires is wound on a 6 millimeter diameter polyethylene rod. The pitch or distance between turns is 4 millimeter. The wire wrapped rod is enclosed by a polyethylene tube of 9.5 millimeter outer diameter. The helices each have one turn of wire. Six of these rods are arranged in two sets of three, installed and tested in a stripline field applicator

This test shows negative mu for frequencies from about 2.3 to 2.5 GHz, with a minimum value of about −4

### Example 5

Two-turn double helices are formed by rolling up patterns printed on s a substrate using highly conductive ink. Two parallel lines are printed at a calculated angle on paper using a silver-containing conductive ink. The substrate is then rolled up, forming double helices.

The numerical models predicted a resonance 1.82 GHz for the dimensions used. The experimental result was approximately 1.7 GHz. As was shown by Pendry and Holden [4], the dc conductivity of the conductors directly impacts the magnitude of the response. With the wire helices, the resonance was very sharp, due to the high conductivity of Cu metal, whereas with the printed helices with lower conductivity, the resonance was just strong enough to yield a minimum of −1 for the real part of the mu. This sample has a negative mu from roughly 1.8 GHz to 2.2 GHz.

### Example 6

A medium having a negative μ of minus one at 6.91 GHz is dispersed in an open cell metal foam having a strut thickness of 1 mm and an effective lattice constant of 10 mm to produce a composite material for imaging 6.91 GHz electromagnetic radiation.

### Example 7

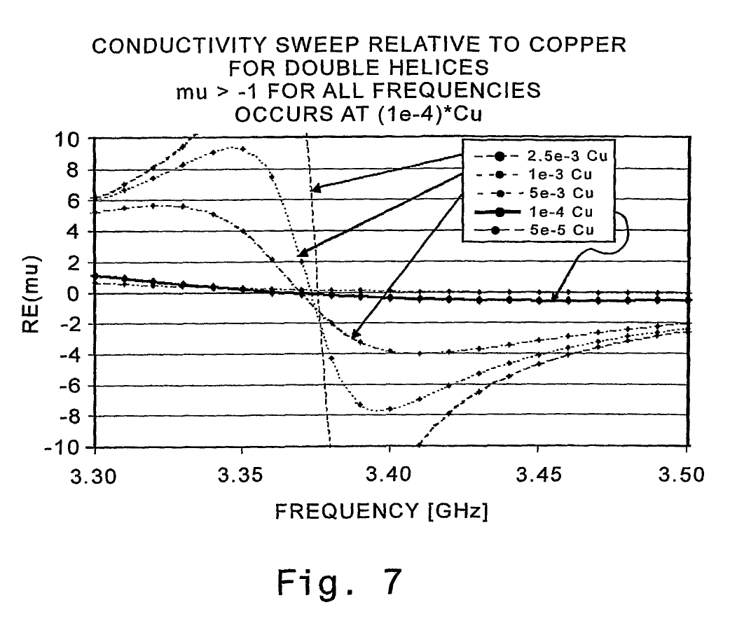

This example examines the minimum conductivity required to be effective as a negative μ material. Specifically, FIG. 7 shows when the DC value of the electrical conductivity of the helical resonators takes a value of 1e-4 times that of Copper, there is no longer any value of the magnetic permeability that is less than or equal to −1. A value of −1 is shown by Pendry to be a requirement for perfect sub-wavelength imaging. DNA's electrical conduction mechanism is ionic charge transfer. DNA's conductivity will never be as good as the most conductive salt water and the most conductive salt water has a maximum conductivity less than 1e-4 times that of Copper. Therefore, DNA in its natural form is not expected to work in negative-refractive index materials.

1. A structure with magnetic properties upon receiving electromagnetic radiation, comprising: an array of capacitive elements, each capacitive element including a low resistance conducting path provided by a conductor having a major and a minor dimension in cross-section perpendicular to the path, and being such that a magnetic component of received electromagnetic radiation lying within a predetermined frequency band induces an electrical current to flow around the path and through the associated element, and the elements having a size and a spacing apart from one another selected such as to provide a negative effective magnetic permeability over a selected frequency range in response to the received electromagnetic radiation, the conductor being in the shape of a multiple helix having a pitch angle of at least 30°, wherein the structure is a meta-material.

2. The structure according to claim 1, in which a diameter of the helix is substantially less than a wavelength of the received electromagnetic radiation.

3. The structure according to claim 2, in which the diameter of the helix is at least an order of magnitude less than the wavelength of the received electromagnetic radiation.

4. The structure according to claim 1, wherein the conductor is comprised of metal particles in electrical communication.

5. The structure according to claim 4, wherein the metal particles are associated with a structure selected from the group consisting of a helical micro-phase of a segregated polymer and a doublehelix protein.

6. The structure according to claim 1, wherein the conductor comprises electrically conducting carbon.

7. The structure according to claim 1, wherein the conductors comprise a double helix of electrically conducting polymers.

8. The structure according to claim 1, comprising four conductors in the shape of a quadruple helix.

9. The structure according to claim 1, wherein the ratio of the major dimension to the minor dimension of the conductor in cross-section perpendicular to the path is less than ten.

10. The structure according to claim 1, wherein the ratio of the major dimension to the minor dimension of the conductor in cross-section perpendicular to the path is less than five.

11. The structure according to claim 1, wherein the ratio of the major dimension to the minor dimension of the conductor in cross-section perpendicular to the path is about two.

12. The structure of claim 1 wherein the pitch angle is greater than 40°.

13. An improved method for producing an integrated circuit including the step of photolithography of a mask work by projecting an image of a mask onto a substrate using an imaging optical system, wherein the improvement comprises an imaging optical system comprising the structure of claim

14. A method for providing a negative effective magnetic permeability over a selected frequency range in response to received electromagnetic radiation, comprising the step of positioning the structure of claim 1 in electromagnetic radiation of the selected frequency range.

15. A medium operable to have at least one frequency band in which both effective μ and effective ε are negative simultaneously, the medium comprising: (a) a negative μ medium comprising the structure of claim 1; and (b) a negative ε medium spatially combined with said negative μ medium to form the composite medium having a frequency band in which both effective μ and effective \acute{ε} are negative.

16. The medium of claim 15, wherein the effective μ and effective \acute{ε} are each about negative one.

17. An improved method for microwave imaging wherein the improvement comprises an imaging system comprising the structure of claim 1.

18. A medium operable to have at least one frequency band in which effective ε is negative the negative ε medium comprising an open cell conductive structure.

19. The medium of claim 18, wherein the open cell conductive structure comprises a metal.

20. The medium of claim 18, wherein the open cell conductive structure comprises a foam structure.

21. The medium of claim 20, wherein the foam structure comprises a metal.

22. A method for producing a negative ε medium comprising the step of configuring conductor shapes in three dimensional space using rapid prototyping.

23. A method for producing a negative μ medium comprising the step of configuring conductor shapes in three dimensional space using rapid prototyping.
